(19) United States
(12) Patent Application Publication
(10) Pub. No.: US 2006/0039386 A1
(43) Pub. Date: Feb. 23, 2006

(54) Internet protocol installer

(75) Inventor: Sang-wook Park, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/192,134

(22) Filed: Jul. 29, 2005

(30) Foreign Application Priority Data
Aug. 23, 2004 (KR) 10-2004-0066276

(51) Int. Cl. H04L 12/66; H04L 12/56

(52) U.S. Cl. 370/401; 370/352

(57) ABSTRACT

Provided is a private Internet Protocol (IP) installer for a home network. The Internet Protocol (IP) installer includes a network interface connected to an IP sharing router, a user interface which receives a user's command, an IP installing unit which assigns private IP addresses to products constituting a home network using an IP sharing router connected to the network interface in response to a user's command input through the user interface, and a display unit which displays a process of assigning the private IP addresses to the products.

### CROSS-REFERENCE TO RELATED APPLICATION

This application claims benefit from Korean Patent Application No. 10-2004-0066276 filed on Aug. 23, 2004 in the Korean Intellectual Property Office, the disclosure of which is incorporated herein by reference in its entirety.

### BACKGROUND OF THE INVENTION

1. Field of the Invention

The present invention relates to a home network and, more particularly, to a private Internet Protocol (IP) installer for a home network.

2. Description of the Related Art

Recently, research on home networks has been actively carried out and fundamental technologies for home networks have been developing rapidly. Once a home network is set up, products in a home are connected through the home network, so they can not only exchange information but also directly receive information through the external Internet.

Each of the products constituting a home network should have an Internet Protocol (IP) address for home networking. Actually, assigning an IP address to each of products constituting a home network may cost a great deal of money. Korean Patent Publication No. 2000-0063781 has disclosed a method for dynamically assigning an IP address to each of the products constituting a home network to reduce the cost required for IP address assignment. In recent years, home networks have been configured using IP sharing routers.

FIG. 1 illustrates an example of a home network configured using an IP sharing router.

The home network of FIG. 1 includes an IP sharing router 110, a computer 120, a telephone 132, a television 134, and a refrigerator 136.

An Internet Service Provider (ISP) assigns a public IP address to the IP sharing router 110, and the IP sharing router 110 assigns a private IP address to each of products constituting the home network.

A private IP address cannot be used on the Internet and is only available on the internal network. With an increase in the number of network products, the number of public IP addresses that are available (not currently used) is decreasing. The use of a private IP address is helpful in obviating the shortage of public IP addresses. Such a private IP address was previously reserved for a private network by the Internet Assigned Numbers Authority (IANA) that manages all IP addresses.

For example, if a public IP address assigned to the IP sharing router 110 is 168.219. 13.132, the IP sharing router 110 can have 192.168.1.100 as its private IP address in the home network. Similarly, the computer 20 has 192.168.1.101 as its private IP address, the telephone 132 using Voice over Internet Protocol (VoIP) has 192.168.1.102 as its private IP address, the television 134 has 192.168.1.103 as its private IP address, and the refrigerator 136 has 192. 168.1.104 as its private IP address.

As such, to assign private IP addresses for the home network, the computer 120 is required. In other words, a user assigns IP addresses to the IP sharing router 110, the computer 120, the telephone 132, the television 134, and the refrigerator 136. A product whose IP address is installed can function as a component of the home network. However, in a home that does not currently use or cannot use a computer, it may be difficult to assign IP addresses for a home network. Therefore, there is a need for an IP installer that assigns IP addresses in an environment where a computer cannot be used.

### SUMMARY OF THE INVENTION

Additional aspects and/or advantages of the invention will be set forth in part in the description which follows and, in part, will be apparent from the description, or may be learned by practice of the invention.

The present invention provides an IP installer private Internet Protocol (IP) installer for a home network.

According to an aspect of the present invention, there is provided an IP installer. The IP installer includes a network interface connected to an IP sharing router, a user interface that receives a user's command, an IP installing unit that assigns private IP addresses to products constituting a home network using an IP sharing router connected to the network interface in response to a user's command input through the user interface, and a display unit that displays a process of assigning the private IP addresses to the products.

According to another aspect of the present invention, there is provided an Internet Protocol (IP) installer including an external port which is connected to the Internet through an external line, a user interface which receives a user's command, an IP installing unit which assigns private IP addresses to products constituting a home network in response to a user's command input through the user interface and which translates the private IP addresses of the products into public IP addresses to allow each of the products to be connected to the Internet, and a display unit which displays a process of assigning the private IP addresses to the products.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates an example of a conventional home network;

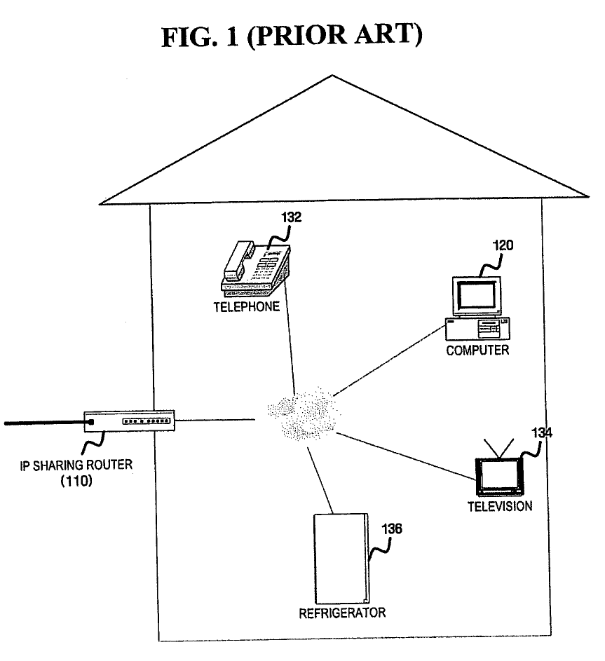

FIG. 2 illustrates an example of an IP installer according to an embodiment of the present invention;

FIG. 3 illustrates an example of an IP installer according to an embodiment of the present invention;

FIG. 4 illustrates an example of an IP installer according to an embodiment of the present invention;

FIG. 5 illustrates a network state screen according to an embodiment of the present invention;

FIG. 6 illustrates a static IP installation screen and a dynamic IP installation screen according to an embodiment of the present invention;

FIG. 7 is a flowchart illustrating a static IP installation process according to an embodiment of the present invention; and

FIG. 8 is a flowchart illustrating a dynamic IP installation process according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims.

Preferred embodiments of the present invention will now be described in detail with reference to the accompanying drawings. In the embodiments of the present invention, a description of IP installation using an IP sharing router will be focused on. However, IP installation using an IP sharing router is only taken as an example and IP installation can be performed without using an IP sharing router.

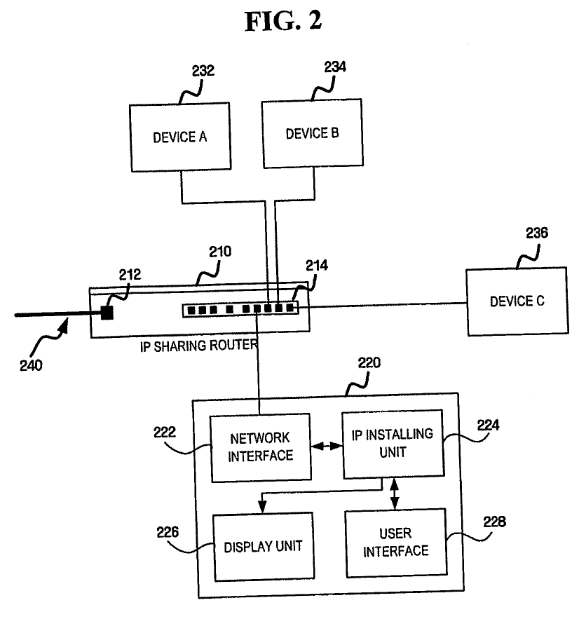

FIG. 2 illustrates an example of an IP installer according to a first embodiment of the present invention.

A home network includes an IP sharing router 210, an IP installer 220, and a plurality of devices 232, 234, and 236.

The IP sharing router 210 is connected to the Internet through an external port 212 using an external line 240, which is connected to each of the products constituting the home network through an internal port 214. The IP sharing router 210 includes dynamic host configuration protocol (DHCP) and network address translation (NAT) functions.

DHCP automatically provides a client with the IP address of a host and default settings of various TCP/IP protocols. The standards for DHCP are defined in RFC 2131, and DHCP uses a client/server model in which an IP address used in a network is controlled by a DHCP server in a centralized way. A DHCP client can request and get an IP address from the DHCP server during network booting. The DHCP function is performed by DHCP agents such as a DHCP server and a DHCP client.

The DHCP server is a program that is executed on a server having an IP address for a network interface, and provides another client with IP addresses taken from a specific range, thereby automatically assigning an IP address thereto. Also, the DHCP server allows the client to maintain the IP address without change.

Once a system starts, the DHCP client requests an IP address for itself from the DHCP server. Once the DHCP client is assigned the IP address by the DHCP server, TCP/IP settings are initialized and the DHCP client can communicate with other hosts using TCP/IP. The DHCP client is a program (executed by a client) that can use DHCP that can search for a network setting value (such as a MAC address) related to an IP address of a network interface. The DHCP client can continuously maintain a previously assigned IP address. The old version of DHCP maintains IP address state information for a short period of time, but the latest version of DHCP can maintain IP address state information without a specific request from a protocol and thus overload caused by network broadcasting may be reduced.

NAT is the translation of a public IP address in an internal network using a private IP address that is different from that known to an external network. NAT may be classified as either dynamic address translation or static address translation. Dynamic address translation involves dynamically translating a source address of outgoing traffic, so that a direct external connection cannot be made to an internal address. Static address translation is used when a server that should be accessed by an external network exists in an internal network. In NAT with static address translation, an administrator maps a public IP address to an internal private IP address in units of a host or a network by directly inputting an address translation table, thereby allowing external access to a server having a non-public IP address using a public IP address.

The IP sharing router 210 performs the NAT function. The IP sharing router 210 is assigned an IP address by an Internet Service Provider (ISP) through the external line 240 using Point-to-Point Protocol (PPP) or point-to-point protocol over Ethernet (PPPoE).

PPPoE is the specification for connecting multiple users using the same Ethernet to a remote site through client's common equipment such as a modem. PPPoE can be used for all the users in an office or a building to share one ADSL (Asymmetric Digital Subscriber Line) or VDSL (Very High-Data Rate Digital Subscriber Line) connection, one cable modem, or a wireless connection and to access the Internet. PPPoE is a combination of PPP that is frequently used in a dial-up connection and Ethernet protocol supporting multiple users in a local area network (LAN). PPP information is encapsulated into an Ethernet frame.

The IP sharing router 210 is assigned an IP address by an ISP and is connected through the internal port 214 to products that are assigned private IP addresses. The IP installer 220 assigns a private IP address to each of the products constituting the home network. For example, once the IP installer 220 is assigned 221.100.10.1 by the ISP, the IP installer 220 reserves 198.126.10.2 for its private IP address, assigns 198.126.10.3 to device A 232 as a private IP address, assigns 198.126.10.4 to device B 234 as a private IP address, and assigns 198.126.10.5 to device C (236) as a private IP address. If device A 232 desires to transmit data to an external device through the Internet, it cannot directly use 198.126.10.3, because 198. 126.10.3 is a private IP address, but instead should use the public IP address 221.100.10.1 that is assigned to the IP sharing router 210. The IP sharing router 210 translates the source address of data transmitted by device A 232 to 221.100.10.1 and transfers the data to the external device. To allow data to be transferred by the external device to device A 232, the port number of device A 232 is added to the source address of the data transmitted by device A 232, i.e., 221.100.10.1. For example, when the port number of the IP installer 220 is 6060, the port number of device A 232 is 7070, the port number of device B 234 is 7070, and the port number of device C 236 is 9090, the IP sharing router 210 translates the source address of data transmitted by device A 232 to the external device to 221.100.10.1 and its port number is 7070. When the destination address of data transmitted by the external device is 221.100.10.1 and its port number is 7070, the IP sharing router 210 translates the destination address of the data to 198.126.10.3 and transfers the data to device A 232.

The IP installer 220 includes a network interface 222, an IP installing unit 224, a display unit 226, and a user interface 228.

The network interface 222 allows the IP installer 220 to be connected to other products and perform networking. The network interface 222 has an inherent physical address (MAC address) of 48 bits.

The IP installing unit 224 makes it possible to assign an IP address to each of the products constituting the home network using the IP sharing router 210. According to an embodiment of the present invention, IP installation may be one of dynamic IP installation and static IP installation. Dynamic IP installation is performed according to a DHCP mode, and the IP installing unit 224 serves as the DHCP server. IP installation will be described in detail later.

The user interface 228 receives a user's command and transmits the received user's command to the IP installing unit 224 to allow the IP installing unit 224 to perform IP installation.

The display unit 226 displays an IP installation process to allow a user to confirm the IP installation process. When the display unit 226 includes a touch-screen function, the user interface 228 can be provided as an on screen display (OSD). In this case, the display unit 226 may entirely or partially perform the role of the user interface 228. The display unit 226 may be implemented by a cathode ray tube (CRT), a plasma display panel (PDP), and a liquid crystal display (LCD). Thus, the IP installer 220 can be implemented by including an IP installation function on a conventional monitor or television.

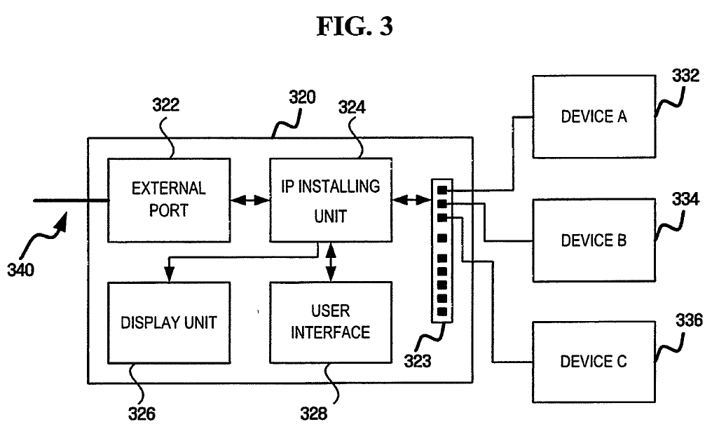

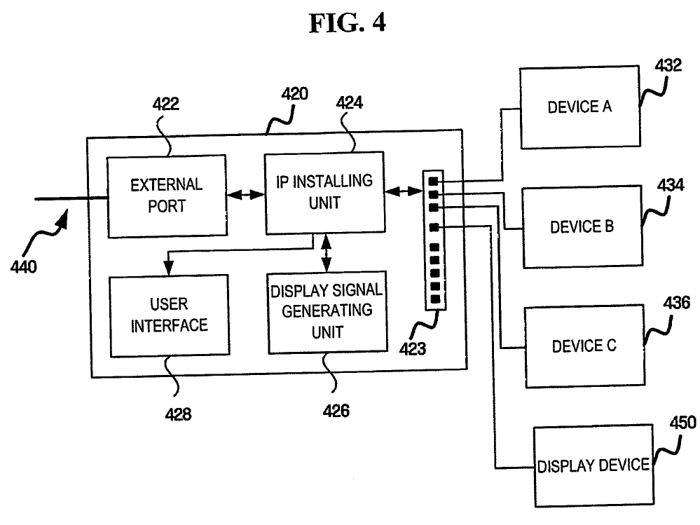

The IP installer 220 described above is only an example. FIGS. 3 and 4 show IP installers that are implemented differently from the IP installer 220 of FIG. 2.

FIG. 3 illustrates an example of an IP installer according to a second embodiment of the present invention.

Unlike the IP installer 220 of FIG. 2, an IP installer 320 of FIG. 3 includes functions of an IP sharing router. Thus, the IP installer 330 further includes an internal port 323 to which other products can be connected and an external port 322 that can be connected to an external line 340.

Operations of a display unit 326 and a user interface 328 are detailed in the description of corresponding components of the IP installer 220 of FIG. 2.

An IP installing unit 324 functions as a DHCP server to assign a private IP address and as NAT to allow products connected to a home network to be connected to the external Internet.

FIG. 4 illustrates an example of an IP installer according to a third embodiment of the present invention.

Unlike the IP installer 220 of FIG. 2 and the IP installer 320 of FIG. 3, an IP installer 420 of FIG. 4 does not include a display unit. Thus, a user can confirm the IP installation process through a display device 450. To this end, the IP installer 420 includes a display signal generating unit 426 to generate a display signal for the display device 450.

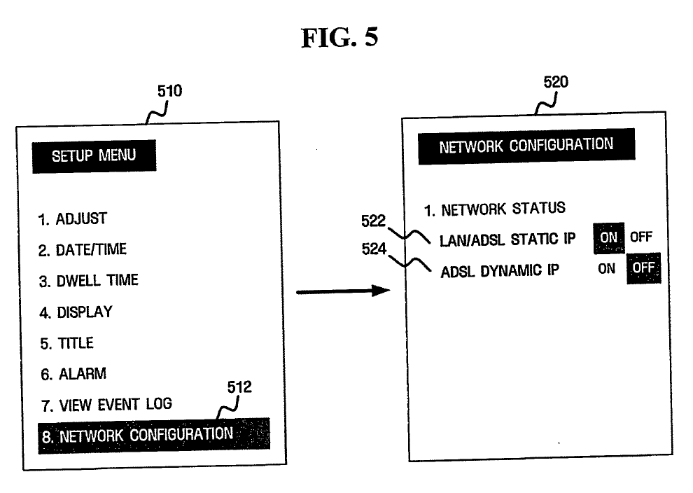

FIG. 5 illustrates a network state screen according to an embodiment of the present invention.

A user commands IP installation using a user interface of an IP installer, but before this the user determines a network state.

Once a user selects a setup menu, a setup menu screen 510 is displayed. In a setup menu, various menus for a setup operation of the IP installer are provided and one of them is a network configuration menu 512. Once the user selects the network configuration menu 512, a network configuration screen 520 is displayed.

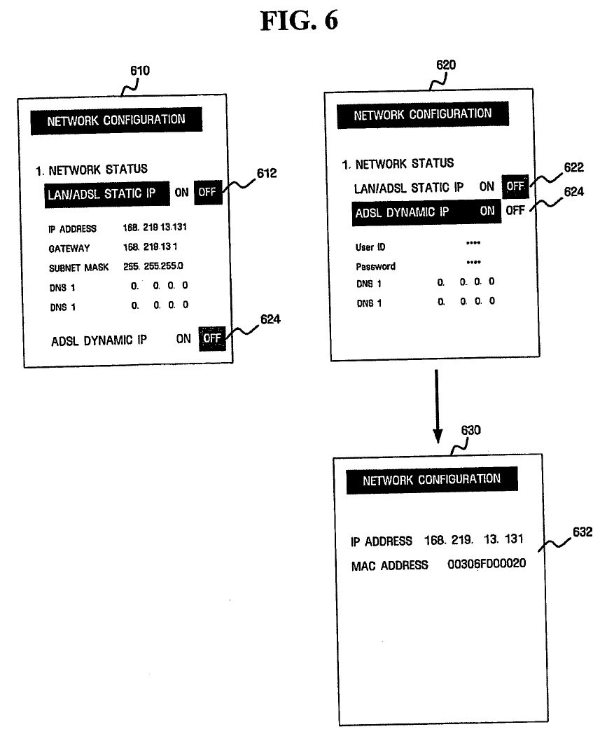

The network configuration screen 520 shows a static IP state 522 and a dynamic IP state 524. When the static IP state 522 is “ON,” the dynamic IP state 524 is “OFF.” A static IP installation process and a dynamic IP installation process are shown in FIG. 6.

FIG. 6 illustrates a static IP installation screen and a dynamic IP installation screen according to an embodiment of the present invention.

When a user sets a static IP state 612 to “ON,” input fields of an IP address, a gateway address, and a subnet mask are displayed on a network configuration screen 610 to allow the user to manually enter an IP address. At this time, a dynamic IP state 614 is set to “OFF.”

When the user sets the dynamic IP state 614 to “ON,” input fields of a user ID and a password are displayed on the network configuration screen 620. At this time, the static IP state 622 is set to “OFF.” After entering the user ID and the password, the user is assigned a dynamic IP address, and assigned IP and MAC addresses 632 are displayed on a network configuration screen 630.

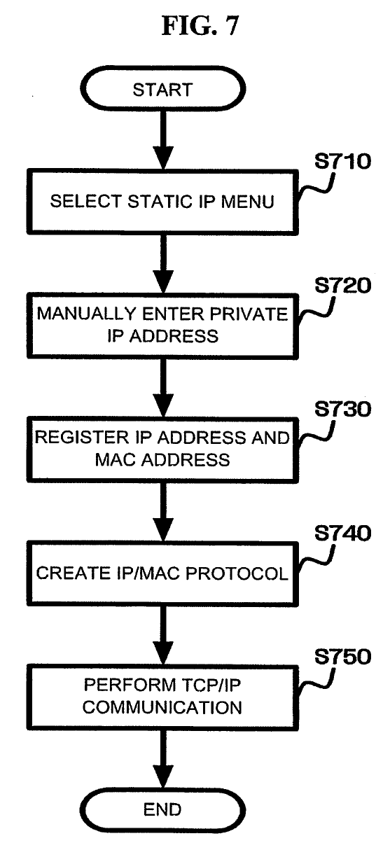

FIG. 7 is a flowchart illustrating a static IP installation process of an IP installer, according to an embodiment of the present invention.

For static IP installation of an IP installer, a user selects a static IP menu by setting a static IP state to “ON” using a user interface in step S710. Upon the user's selection of the static IP menu, a screen is provided to allow the user to manually enter an IP address. Once such a screen is provided, the user enters the IP address using the user interface in step S720. After the IP address is input, an IP address and a MAC address of the IP installer are registered in step S730.

Once the IP address and the MAC address are registered, the IP installer creates IP/MAC protocol to create data packets in step S740. After creating the data packets, the IP installer performs TCP/IP communication in step S750.

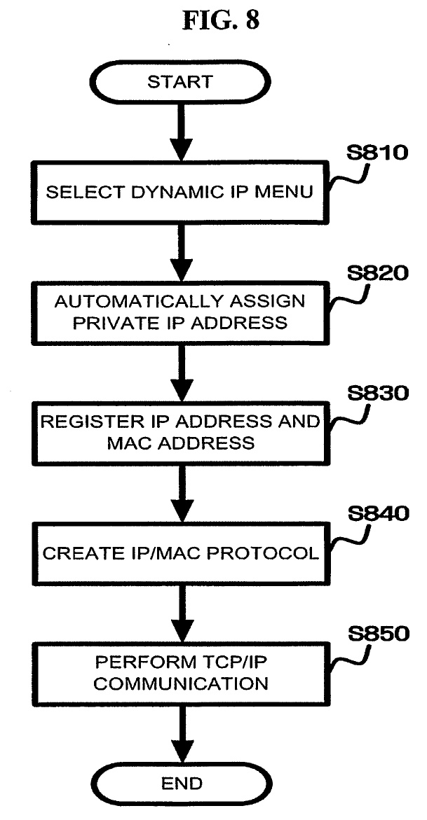

FIG. 8 is a flowchart illustrating a dynamic IP installation process of an IP installer, according to an embodiment of the present invention.

For dynamic IP installation of an IP installer, a user selects a dynamic IP menu by setting a dynamic IP state to “ON” using a user interface in step S810.

Upon the user's selection of the dynamic IP menu, the IP installer is dynamically assigned an IP address through a DHCP operation in step 820.

After the IP installer is assigned the IP address, an IP address and a MAC address of the IP installer are registered in step S830.

Once the IP address and the MAC address are registered, the IP installer creates IP/MAC protocol to create data packets in step S840. After creating the data packets, the IP installer performs TCP/IP communication in step S850.

The private IP installer includes a network interface connected to an IP sharing router, a user interface which receives a user's command, an IP installing unit which assigns private IP addresses to products constituting a home network using an IP sharing router connected to the network interface in response to a user's command input through the user interface, and a display unit which displays a process of assigning the private IP addresses to the products.

While the present invention has been particularly shown and described with reference to exemplary embodiments thereof, it will be understood by those of ordinary skill in the art that various changes in form and details may be made therein without departing from the spirit and scope of the present invention as defined by the following claims.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An Internet Protocol (IP) installer, comprising:
an IP sharing router;
a network interface connected to the IP sharing router; and
an IP installing unit which assigns private IP address(es) to product(s) constituting a network using the IP sharing router connected to the network interface.

2. The IP installer of claim 1, wherein the IP installing unit assigns private IP address(es) to the product(s) according to a dynamic IP installation.

3. The IP installer of claim 1, wherein the IP installing unit assigns private IP address(es) to the product(s) according to a static IP installation.

4. The IP installer of claim 1, further comprising:
a user interface which receives a user's command.

5. The IP installer of claim 1, further comprising:
a display unit which displays a process of assigning the private IP address(s) to the product(s).

6. The IP installer of claim 1, wherein the IP sharing router comprises a dynamic host configuration protocol (DHCP) and a network address translation (NAT).

7. The IP installer of claim 6, wherein the network address translation comprises one of a dynamic address translation and a static address translation.

8. An Internet Protocol (IP) installer, comprising:
an external port which is connected to the Internet through an external line;
a user interface which receives a user's command;
an IP installing unit which assigns private IP address(s) to product(s) constituting a home network in response to a user's command input through the user interface and which translates the private IP address(es) of the product(s) into public IP address(es) to allow each of the product(s) to be connected to the Internet; and
a display unit which displays a process of assigning the private IP address(es) to the product(s).

9. The IP installer of claim 8, wherein the IP installing unit assigns private IP address(es) to the product(s) according to dynamic IP installation.

10. The IP installer of claim 8, wherein the IP installing unit assigns private IP address(es) to the product(s) according to static IP installation and the private IP address(es) of the product(s) are input through the user interface.

11. A method for assigning a private address to an apparatus connected to an IP sharing router, comprising:
connecting a network interface to the IP sharing router; and
assigning the private address to the apparatus of the IP sharing router using the network interface.

12. The method of claim 11, wherein the assigning operation responses to in accordance with a user's command.

13. The method of claim 11, further comprising:
displaying the assigning operation to a display unit.

14. The method of claim 11, wherein the display unit is a Cathode Ray Tube (CRT).

15. The method of claim 11, wherein the display unit is a Plasma Display Panel (PDP).

16. The method of claim 11, wherein the display unit is a Liquid Crystal Display (LCD).

17. An Internet Protocol (IP) installer connected to an IP sharing router comprising:
a network interface connected to the IP sharing router; and
an IP installing unit which assigns private IP addresses to products constituting a home network using an IP sharing router connected to the network.

18. The Internet Protocol (IP) installer of claim 17, further comprising:
a user interface which receives a user's command.

19. The Internet Protocol(IP) installer of claim 17, further comprising:
a display unit which displays a process of assigning the private IP addresses to the products.

20. A system, comprising:
an IP sharing router capable to an external network and connected to an internal apparatus; and
an IP installer unit connected to the router and assigning a private IP address to the apparatus.
